(19) United States
(12) Patent Application Publication
(10) Pub. No.: US 2009/0079711 A1
(43) Pub. Date: Mar. 26, 2009

(54) Scrolling Device

(75) Inventors: Patrick Monney, (US); Marc Bidiville, (US); Philippe Junod, (US); Baptiste Merminod, (US); Antoine Merminod, (US); Rolf Ambuehl, (US); Guy Tiphane, Atherton, CA (US); Rene Sommer, (US); Florian Kehlstadt, (US); Laurent Plancherel, (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Logitech Europe S.A., Romanel-sur-Morges (CH)

(21) Appl. No.: 12/237,262

(22) Filed: Sep. 24, 2008

Related U.S. Application Data
(62) Division of application No. 10/884,543, filed on Jul. 2, 2004, now abandoned.

(51) Int. Cl. G06F 3/033

(52) U.S. Cl. 345/184

(57) ABSTRACT

A control device includes a case having a bottom surface that has a front portion and a back portion; and a first friction pad and a second friction pad disposed on the front portion of the bottom surface. The first and second friction pads are configured to detect pressure from a user hand to power-up the control device. The first and second friction pads are also configured to detect the absence of the user hand and place the control device in a sleep mode based on the detection of the absence of the user hand.

### CROSS REFERENCE TO RELATED APPLICATIONS

This application is a divisional application of, and claims priority to, U.S. patent application Ser. No. 10/884,543, filed Jul. 2, 2004, titled “Scrolling Device,” of Patrick Monney et al., and which is incorporated by reference herein in its entirety for all purposes.

This application is related to U.S. patent application Ser. No. ______ (attorney docket no. 09623C-046910US), filed Sep. 24, 2008, titled “Scrolling Device,” of Patrick Monney et al., and which is incorporated by reference herein in its entirety for all purposes.

### BACKGROUND OF THE INVENTION

The present invention relates generally to control devices and control methods. More particularly the present invention relates to control devices for controlling graphical objects displayed on a display.

Typical control devices, such as mice and track balls, configured to control graphical objects displayed on monitors typically provide y-scrolling but fail to provide for x-scrolling and z-scrolling. X-scrolling is desired for graphical objects that do not fit within the x-dimension of a computer monitor. Typically x-scrolling is controlled by positioning a pointer on a scroll bar or scroll button displayed on a computer monitor and dragging the scroll bar or pushing on the scroll button. Such control of x-scrolling requires a number of user interactions with a control device and a computer, and as such tends to be slow and cumbersome. Additionally, z-scrolling is desired for moving through image planes of an image or enlarging or shrinking images displayed on a monitor.

Other control devices designed to provide scrolling control include devices discussed in U.S. Pat. No. 6,128,006, filed Oct. 3, 2000, titled “Force Feedback Mouse Wheel And Other Control Wheels,” owned by Immersion Corporation; and in U.S. patent application Ser. No. 10/184,000 (U.S. Patent Application Publication No. 2003/0025673), filed Feb. 6, 2003, titled “Input Device Including a Wheel Assembly For Scrolling an Image In Multiple Directions;” and in U.S. patent application Ser. No. 09/843,794 (U.S. Patent Application Publication No. 2002,0158844), filed Apr. 30, 2001, titled “Input Device Including a Wheel Assembly For Scrolling an Image In Multiple Directions,” owned by Microsoft Corporation.

Accordingly, what is needed are new control devices and new control methods for controlling graphical objects displayed on a display.

### BRIEF SUMMARY OF THE INVENTION

A control device is provided for controlling graphical objects displayed on a computer monitor. According to one embodiment the control device includes a housing; a roller ball mechanism disposed in a front portion of the housing; a first button disposed on a first side of the roller ball; a second button disposed on a second side of the roller ball; and a x/y displacement controller, such as an x/y displacement sensor or a another roller ball mechanism disposed, for example, behind the first mentioned roller ball mechanism. According to a specific embodiment, the roller ball mechanism includes a roller ball having a patterned surface; and a roller ball detector configured to detect the pattern as the roller ball is rotated and encode rotations for control of the graphical objects. According to another specific embodiment, the roller ball mechanism further includes a pressure sensor configured to sense a downward force placed on the roller ball and change a control characteristic of the control ball. According to another specific embodiment, the control characteristic includes z-scrolling.

According to another embodiment, a control device is provided that includes a friction pad (or slider) device configured to control scrolling of a graphical object displayed on a monitor. The slider device includes a slider button guided by a slider guide configured to limit the slider button to motion approximately along an axis. In a forward position, the slider button is configured to control scrolling in a first direction along the axis, and in a back position, the slider button is configured to control scrolling in a second direction along the axis.

According to another embodiment, an input device is provided that includes a control device, such as a joystick. The joystick is configured to control scrolling of graphical objects displayed on a display. Scrolling rates of graphical objects may be increased or decreased with increasing or decreasing forces placed on the joystick by a user.

According to another embodiment, a control device is provided that is configured to cause a drop down menu to be displayed on a display based on a user action, wherein the drop down menu includes selectable options for changing an operating characteristic of the control device. Selectable operating characteristics may include a mouse function, a TV control function, a slide projector control function or other functions.

According to another embodiment, a control device is provided that includes a force feedback module configured to place programmable feedback forces on a scroll wheel, such that the feedback forces (e.g., ratcheting forces) are generated synchronous with encoded scroll signals. Such control device reduces problems associated with synchronizing mechanical feedback generated by the scroll wheel with encoded scroll signals. According to some embodiments, the number of ratcheting steps are programmable (i.e., number of ratcheting forces per turn of the scroll wheel are controllable), or the ratcheting forces may be suppressed.

According to another embodiment, a control device is provided that includes a scroll wheel disposed on a side of the control device for activation by a thumb. The scroll wheel may provide a scrolling function and a button function for, respectively, scrolling and selecting graphical objects displayed on a display.

According to another embodiment, a control device is provided that is configured to optically encode dial rotations, such that a radiation source is configured to transmit radiation on a number of slots and bars on a encoder strip coupled to a surface portion of the dial, and variations between transmitted and reflected radiation, associated with rotations of the dial, are encoded to control volume of sound generated by the sound system of a computer, graphical objects displayed on a monitor. The control device might be formed in a keyboard or other input device to provide the functions described. The control device might be configured as volume control device for a computing device or might be configured to control graphical object displayed on a display of the computing device.

According to another embodiment, a control device is provided that includes a scroll wheel configured to scroll through a plurality of text pages or a plurality of lines via a single push by a user to spin the scroll wheel. The scroll wheel may have a relatively high moment of inertia (e.g., made of a relatively dense material and with relatively high perimeter weighting), a relatively low friction bearing, and may be configured not to provide a force feedback (ratcheting) limiting the friction forces on the scroll wheel. According to a specific embodiment, a scroll wheel is coupled to a motor configured to provide a controllable torque to the scroll wheel to simulate a scroll wheel having a relatively high moment of inertia. The torque applied to the scroll wheel might be controlled by controlling the current supplied to the motor.

According to another embodiment, a control device is provided that includes a scroll wheel having a plurality of ribs disposed on an annular portion of the scroll wheel. The ribs are configured to interleave with a corresponding plurality of ribs on a support structure. The ribs on the support structure might me mounted on a ring that is configured to rotate such that rotations of the ring (and rotations the scroll wheel) might be encoded by an encoder.

According to another embodiment, a control device is provided that includes a scroll wheel configured to provide force feedback, such as ratcheting, such that ratcheting forces placed on the scroll wheel may not align with encoder signals generated by encoder means of the control device. According to a specific embodiment, the control device's microprocessor is configured to run an adaptive algorithm program that is configured to perform the synchronization between the scroll wheel reports and the ratcheting steps. For example, eight counts of the encoder correspond to one ratchet, and if the scroll wheel remains stopped for a predetermined period of time (e.g., two seconds), the control device's position counter might be set to zero. When the scroll wheel starts moving again (i.e., rotated by a user), the countable states are counted (plus or minus for forward or back rotation of the scroll wheel), and when half of a counter state is passed (e.g., transition from counter state 4 to 5 or from counter state −4 to −5), a scroll wheel report is generated by the control device. The time at which the report is generated (e.g., half way between two stops) is adjusted to match the time at which the feedback ratchet is generated. As the microprocessor is configured to run the adaptive algorithm program, the report might be generated on time without mechanical alignment of the slots and ratchet steps.

According to another embodiment, a control device is provided that includes first and second control buttons. The control button are configured to control scrolling and a scrolling rate of graphical objects displayed on a monitor. One of the buttons may be configured to control scrolling in a first direction (e.g., positive y-axis), and the other button may be configured to control scrolling in a second direction (e.g., negative y-axis). Scrolling rates of the graphical object may be increased with increasing pressures placed on the buttons.

According to another embodiment, a control device is provided that includes a set of friction pads disposed on a lower surface of the control device and are configured to slide on a surface (e.g., desktop, mousepad, etc.). At least two of the friction pads in the set are coupled to forces sensors that are configured to provide detected force information to a micro-controller running a micro-controller program that is configured to place the control device in a “sleep mode” (i.e., a reduced current consumption mode), leave the control device in a “power up mode” (i.e., normal operation mode), or to transition the control device from the sleep mode to the power up mode based on the detected force information provided by the force sensors.

According to another embodiment, a scroll wheel mechanism is provided that includes a set of toothed wheels, such that the teeth of the wheels are magnetized. One wheel is fixed and the other rotates. The teeth on the respective wheels may be polarized with opposed or attractive magnetic fields. The magnetic forces between the teeth are configured to raise and lower as the teeth on the respective wheels rotate past one another. The raising and lower forces provide ratcheting forces to the toothed wheels that a user may feel as ratchet feedback while using the scroll wheel mechanism in a mouse or other control device.

Other features and advantages of the invention will be apparent in view of the following detailed description and accompanying figures.

### BRIEF DESCRIPTION OF THE DRAWINGS

FIG. 1A, 1B and 1C are simplified schematics of a control device according to an embodiment of the present invention;

FIG. 1D is a simplified schematic of a control device according to another embodiment of the present invention;

FIGS. 2A and 2B are top and cross-sectional views of a control device according to another embodiment of the present invention;

FIG. 2C is a simplified schematic of a control device according to another embodiment of the present invention;

FIG. 2D is a simplified schematic of a control device according to another embodiment of the present invention;

FIG. 3 is a simplified diagram of a selection system according to another embodiment of the present invention;

FIG. 4 is a simplified cross-sectional schematic of a control device according to another embodiment of the present invention;

FIGS. 5A, 5B, and 5C are varying views of a control device having a scroll wheel 505 disposed on a side of the control device according to an embodiment of the present invention;

FIG. 6A is a cross-sectional view of a dial controller according to an embodiment of the present invention;

FIG. 6B is a simplified top view of a portion of the encoder disk and the PCB of the dial controller;

FIG. 6C is a cross-sectional view of a dial controller according to another embodiment of the present invention;

FIG. 7 is a simplified schematic of a scrolling structure that may form a portion of a mouse or the like according to an embodiment of the present invention;

FIGS. 8A and 8B are simplified cross-sectional and top views of a control device according to an embodiment of the present invention;

FIG. 8C is a simplified schematic of a top view of a control device according to another embodiment of the present invention;

FIGS. 8D and 8E are simplified schematics of a control device 800 showing top and front views of the control device according to another embodiment of the present invention;

FIGS. 8F and 8G are simplified top view of control devices having four buttons that may be configured to control scrolling along two axes, such as along the x- and y-axis, along the x- and z-axis, along the y- and z-axis or the like according to another embodiment of the present invention;

FIGS. 9A and 9B are a simplified top and side views of a control device according to an embodiment of the present invention;

FIG. 9C is a simplified schematic of a control device according to another embodiment of the present invention;

FIG. 10 is a simplified schematic of a control device according to an embodiment of the present invention;

FIG. 11A is a simplified end view of a control device having a number of force sensors disposed on a bottom surface according to an embodiment of the present invention;

FIG. 11B is a simplified end view of a control device having a number of force sensors disposed on a bottom surface according to another embodiment of the present invention;

FIGS. 12A and 12B and are simplified side views and FIG. 12C is a simplified top view of a scroll wheel mechanism according to an embodiment of the present invention;

FIG. 12D shows a scroll wheel mechanism according to another embodiment of the present invention; and

FIG. 13 is a simplified diagram of a control device disposed on a mouse type device 1305 according to an embodiment of the present invention.

### DETAILED DESCRIPTION OF THE INVENTION

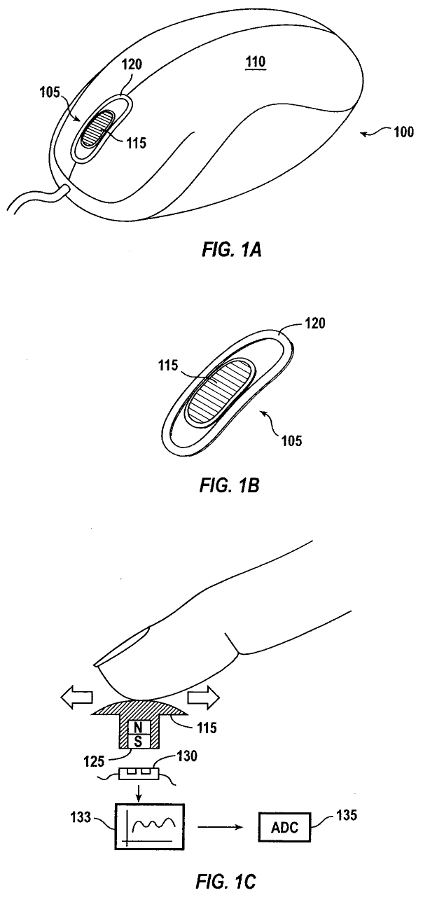

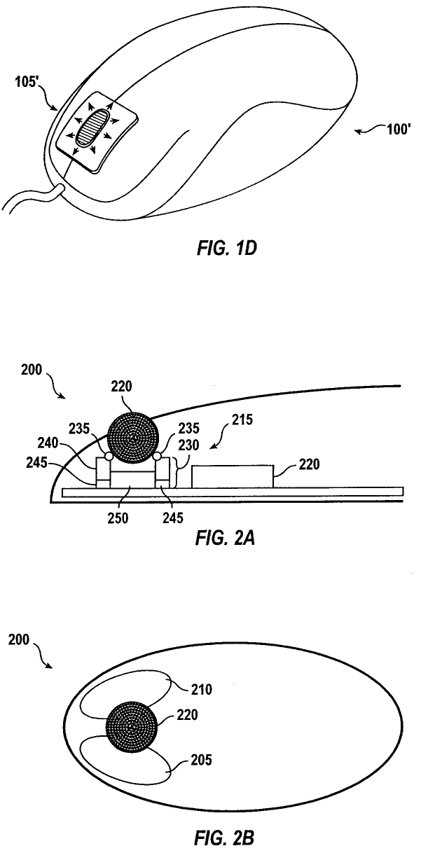

FIG. 1A is a simplified schematic of a control device 100 according to an embodiment of the present invention. Control device 100 may be a mouse type device or the like. Control device 100 includes a slider mechanism 105 disposed in a case 110. The slider mechanism includes a slider button 115 configured to slide forward and backward, for example, under the force of a user's finger. The slider button is configured to slide in a guide 120 (see FIG. 1B) that generally limits sideways motion of the slider and guides the slider in forward and backward travel. The slider may be configured to control graphical object displayed on a computer monitor or the like. For example, the slider may be configured to control scrolling of a pointer, cursor, screen or the like. A variety of encoding means may be used to encode forward and backward signals from the sliders forward and backward travel. For example, a magnet 125 (see FIG. 1C) may be disposed in a bottom portion of the slider and, a detector 130 may be disposed adjacent the magnet to detect the magnets position and encode the position. While the orientation of magnet 125 is shown in FIG. 1C with the north pole of the magnet above the south pole, the magnet may be oriented in a number of different configurations. For example, the north and south poles of the magnet may be rotated approximately ninety degrees from the orientation of the magnet shown in FIG. 1C, or may be disposed in other useful orientations. Detector 130 may be a Hall effect detector, a differential Hall effect detector, a giant magnetoresistive (GMR) sensor, an anisotropic magnetoresistive (AMR) sensor or the like. A Hall effect detector, such as one or more of Infineon's TLE4990, TLE4921, 4923 detectors or Honeywell's SS19 detector, may be used for encoding the magnet's position. Hall effect detector that provide digitized or analog output may be used in accordance with embodiments of the present invention. For example, two Hall effect sensors in a linear series configuration may be a detector configuration used in accordance with an embodiment of the present invention. Other useful encoding means include resistive sensors, capacitive sensors, inductive sensors, and electromechanical encoders. The detection systems described in detail in U.S. Pat. No. 5,911,627 and/or U.S. Pat. No. 6,248,018 might also be used in accordance with embodiment of the present invention and are incorporated by reference in their entirety for all purposes. Analog signals 133 encoded, for example, by a magnetic type sensor may be digitized by an analog to digital converter (ADC) 135 disposed on the control device's printed circuit board. An encoding means may be configured to provide signals that indicate the distance of the slider from the neutral position. Such signals may be used not only for scrolling but also for controlling the speed of scrolling. For example, as the slider is moved further from the neutral position, the scrolling rate may increase with the increasing distance moved. A variety of restoring means, such as simple spring mechanisms, may be used to provide restoring forces to restore the slider to the neutral position subsequent to slider displacement. The restoring means may provide larger restoring forces as the slider is moved further from the neutral position, thus providing tactile feedback for the distance the slider has been moved from the neutral position. A feedback module (not shown) may be configured to provide audible or tactile feedback to a user indicating displacement from the neutral position. For example, the feedback module may include a mechanical vibrator configured to simulate a ratcheting force on a user's finger. The frequency of the ratcheting may be increased as the slider is disposed increasing distances from the neutral position. The feedback module may alternatively include a buzzer configured to provide audible signals as the slider is moved from the neutral position. The audible signal may be generated at increasing frequencies or volume as the slider is moved further from the neutral position. According to one embodiment, feedback module (configured to provide audible or tactile feedback) generates a pulse, sound or vibration for each scroll displacement (for example, for each text line) reported to a host computer or the like. Moving the slider away from the neutral position, the pulses are generated at an initial rate and increase as the slider is moved further away from the neutral position.

The maximum travel of the slider may be set to distances that provide relatively low amounts of stress to the user's finger during use. For example, travel may be set at about +/− about 3 millimeters in the forward and backward sliding directions or any other distance that minimizes finger stress.

Slider mechanism 105 provides a relatively compact means for scrolling control or the like as compared with traditional scroll wheels that are typically large and often consume nearly an entire vertical space of a control device. Thus, slider mechanisms, according to embodiments of the present invention, provide that control devices may be made smaller or include other control electronics that would not otherwise fit in traditional control devices.

FIG. 1D is a simplified schematic of a control device 100′ according to an embodiment of the present invention. Control device 100′ differs from control device 100 in that control device 100′ includes a slider mechanism 105′ that includes a slider 115′ that may be moved in a variety of directions as indicated by the arrows in FIG. 1D. Slider 115′ of slider mechanism 105′ may be configured to control a variety of graphical functions, such as scrolling graphical object along two separate axis of a display (e.g., x-scrolling and y-scrolling). For example, left and right movements of the slider may control x-scrolling, whereas forward and back movements of the slider may control y-scrolling.

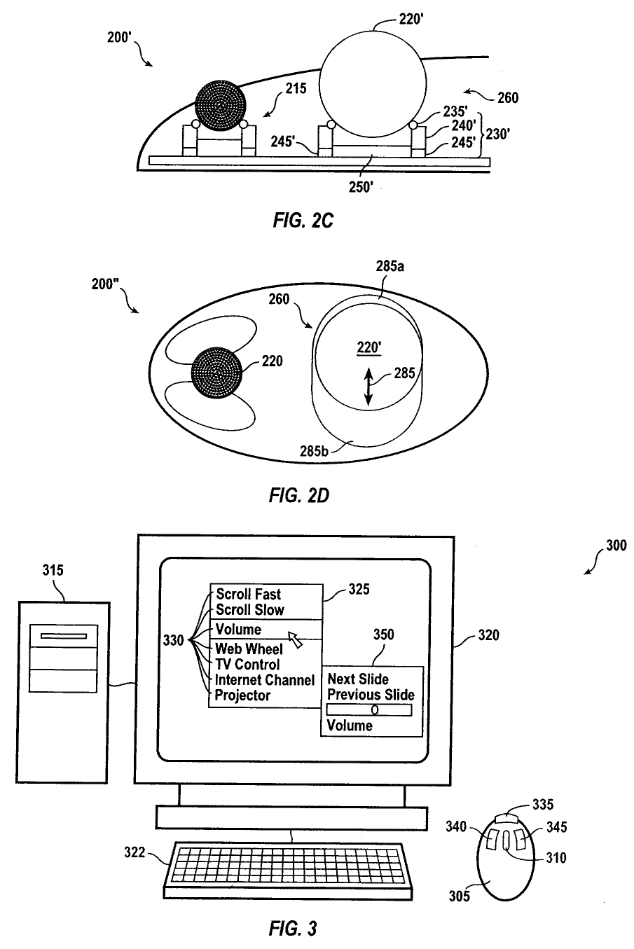

FIGS. 2A and 2B are top and cross-sectional views of a control device 200 according to another embodiment of the present invention. Control device 200 includes a left control button 205, a right control button 210, a roller ball structure 215, and an x/y displacement sensor 220, such as a conventional opto-mechanical roller-ball sensor or an optical type sensor. Control device 200 may be a mouse type device configured to control and manipulate graphical objects displayed on a computer monitor or the like. The left and right buttons may be used for conventional control functions, such as selecting and/or manipulating graphical objects, such as drop down menus, drawing tools, text blocks or the like. The x/y displacement sensor may be configured to control graphical object by detecting movement of the control device as the control device is moved relative to a surface, such as a table, a mouse pad or the like. Roller ball structure 215 may be configured to provide movement control signals (e.g., two movement control signals) for controlling movement of graphical objects, a cursor, scrolling a screen and the like. Roller ball structure 215 includes a roller ball 220, a ball-displacement sensor 225, and a support structure 230. Supports structure 230 might include a plurality of bearings 235 (e.g., three) having low rolling resistance or low friction coefficient, a plurality of bearing supports 240 (e.g., three), and a set of pressure sensors 245 (e.g., three ), a ball sensor 250. Bearings 235 are configured to support roller ball 220 and allow the roller ball to be rotated in any arbitrary direction. The roller ball may be rotated by a finger of a user using the control device. Roller ball 220 may be relatively heavy providing for smooth operation and momentum control (e.g., flicking the ball with sharp finger push wherein the ball continues to rotate after finger contact has ceased). Roller ball 220 may be coated with an optical-reflection coating having a pattern. Movement of the pattern and the ball may be detected by ball sensor 250, for example, as the roller ball is moved by a user. Ball sensor 250 may be an optical sensor configured to detect movement of the pattern. Detected movements of the roller ball are encoded by the ball sensor and encoded-rotation signals may be transferred to a computation device, such as a personal computer for graphical manipulations or other functions. Any number of different types of illumination (optical, IR, UV or other) devices (not shown) may be used to illuminate the roller ball and provide for optical detection of roller ball 220 by ball sensor 250. Movement detection of a patterned ball is described in detail in U.S. Pat. No. 5,288,993, U.S. Pat. No. 5,703,356, U.S. Pat. No. 5,854,482, U.S. Pat. No. 6,084,574, U.S. Pat. No. 6,124,587, and U.S. Pat. No. 6,218,659, each of which is incorporated by reference in their entirety for all purposes, and are owned by the owner of the presently described invention.

According to another embodiment, bearings 235 may be configured to detect rotation of the roller ball, to transfer rotation signals to a set of encoding slotted disks (e.g., two encoding slotted disks, not shown) for detection by traditional optical barriers, and to transfer the encoded rotation displacement signals to a computing device, such as a personal computer or the like. According to one embodiment, force sensors 250, which are disposed under bearing supports 240, are configured to detect a downward force placed on the roller ball. The force sensors may be configured to perform button type functions. For example, the button functions might provide for selecting a graphical-screen object for moving or other manipulations. Force sensor 245 may be a solid state sensor, such as a piezoelectric device, a simple switch, a piezoresistivity device, such as a piezoresistivity conductive polymer that changes resistance in a predictable manner with the application of a force at its surface, such as the Force Sensing Resistors™ of Interlink Electronics of Carpinteria Calif., or other similarly functioning force detection devices. According to an alternate embodiment, the control device does not include a pressure sensor. According to a further embodiment, roller ball 220 may be configured to provide a throttle function. That is, as the roller ball is rotated an increasing amount from a central position, the control device will output a signal that increases as the rotation increases. Throttle control may be selected by a number of means, such as pushing on the left or right control buttons or activating the pressure sensor by pressing on the roller ball. While control device 200 is shown in FIGS. 2A and 2B as being a mouse type device, the control features (buttons, roller ball, detector, etc.) may be mounted in a keyboard type device, a trackball, a joystick or the like.

FIG. 2C is a simplified schematic of a control device 200′ according to another embodiment of the present invention. Control device 200′ includes a first roller ball structure 215, and a second roller ball structure 260. Control device 200′ may also include left control and right control buttons, such as those shown in FIG. 2B. The left and right buttons may be configured for traditional mouse button applications. Roller ball structure 215 is described in detail above. Similar to roller ball structure 215, roller ball structure 260 may include a roller ball 220′, a ball sensor 250′, and a support structure 230′. Supports structure 230′ includes a plurality of bearings 235′ having low rolling resistance, a plurality of bearing supports 240′, and may optionally include a pressure sensor 245′. Roller ball 220′ is generally larger than roller ball 220 and may be configured for manipulation by one or more fingers or possibly the palm or ball of the hand. Roller ball 220′ may be configured for x- and y-screen navigation and tracking, whereas roller ball 220 may be configured for scrolling.

FIG. 2D is a simplified schematic of a control device 200″ according to another embodiment of the present invention. Control device 200″ is configured similarly to control device 200′ described above, but differs in that roller ball structure 260 and roller ball 220′ are laterally translatable as indicated by double arrow 285. Control device 200″ may also include plates 285a and 285b that are configured to laterally translate with roller ball structure 260. The plates are configured to give the control device a somewhat seamless look and provide a cover for internal electronics and structures. As the roll ball structure 260 is left-right translatable, the control device may be configured for comfortable use by left-handed users or right-handed users. This might include positioning roller ball 220′ in a number of positions to accommodate user preferences and physical comfort, such as roller ball 220′ positioned to a left most or right most position or some where between these two positions, such as in line with roller ball 220 with respect to the side of the case.

FIG. 3 is a simplified diagram of a system 300 according to another embodiment of the present invention. System 300 includes a control device 305 having a scroll wheel 310 and a computation device 315 (e.g., personal computer type device) that includes a monitor 320 and keyboard 322. Control device 305 may be a mouse type device having a wire or wireless coupling to computation device 315. According to one embodiment, scroll wheel 310 is clicked (e.g., pushed to activate a button type function) and based on clicking the scroll wheel, a menu 325 is presented on monitor 320. The menu may include a drop down type menu that appears at the location of a cursor or at another location on the monitor, such as a fixed location. The menu includes a number of selectable options 330 that pertain to control functions of the scroll wheel 310. The selectable options may be variously chosen by i) positioning a cursor over a given option to temporarily activate the option while the cursor overlies the selectable option or ii) by positioning the cursor over the selectable options and “clicking” (a selectable option may be deselected by re-clicking on the selectable option). The menu may include a number of selection options, such as scroll fast, scroll slow, volume, web wheel, TV control, internet channel, projector control or the like. According to a specific embodiment, selecting scroll fast, alters the scroll speed of the scroll wheel from slow to fast, and selecting scroll slow, returns the scroll speed to slow. Positioning the cursor on scroll fast without clicking on scroll fast provides that the scroll wheel will retain scroll fast features as long as the cursor overlies the scroll fast selection option. Positioning the cursor on the scroll fast option and clicking on the option provides that the scroll wheel will maintain the scroll fast feature until deselected by positioning the cursor over the scroll slow selectable option or clicking on scroll slow selectable options. According to another specific embodiment, selecting the TV control configures control device 305 to perform TV control functions, for example, remotely. To implement the remote control embodiment, control device 305 may include an infrared control module 335, or the like, to control a TV or computer providing a TV type presentation. First and second buttons 340 and 345, respectively, may be used for TV channel control and scroll wheel 310 might be configured for use as a volume control in TV mode. According to another specific embodiment, by selecting the volume selectable option, scroll wheel 310 may be configured to perform volume control, for example, for a computer the control device is configured to control. According to another specific embodiment, selecting the projector control selectable option provides that control device 305 may be configured to perform projector control functions. For example, buttons 340 and 345 may be configured to scroll slides back and forth and scroll wheel 310 may be configured as a volume control. According to one embodiment, placing the control device on a desk top, mouse pad or the like temporarily converts the control device back to “normal” control, wherein the buttons and scroll wheel may be configured to select options on computer monitor 320. Lifting the control device from the table reconfigures the control device for TV control, projector control or the like. A detector positioned, for example, on the bottom of the control device may be configured to detect whether the control device is positioned on a desk top or the like. Those of skill in the art will know of a number of detection devices and methods for detecting the placement of the control device on a desk top, mouse pad or the like. The term projector as referred to herein includes traditional slide projectors configured to project photographic slide images, and includes computer projectors that may be configured to project web based presentation slides, PowerPoint™ type slides or the like. According to an alternate embodiment, selecting a TV control selectable option, a projector control selectable option, an Internet channel selectable option or the like triggers the presentation of additional selection menus on computer monitor 320. The additional selection menu may be an additional drop down menu 350 having a number of options for TV control, projector control, Internet control or the like. For example, drop down menu 350 includes a plurality of options for controlling a projected presentation, including next slide, previous slide, a volume slider or the like. According to one embodiment, in a computer controlled slide presentation, a user of control device 300 may be able to view the drop down menu while those viewing the slide presentation are unable to see the drop down menu.

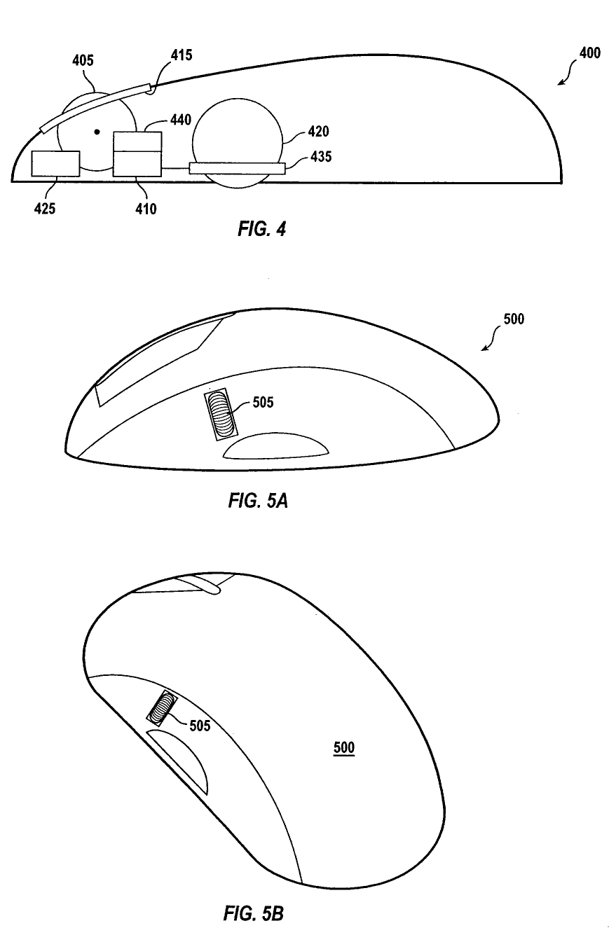

FIG. 4 is a simplified cross-sectional view of a control device 400 according to another embodiment of the present invention. Control device 400 may be a mouse type control device, or various portions of control device 400 may be included in a keyboard or other device. Control device 400 includes a scroll wheel 405, a feedback device 410, a rotation detector 425, and a controller 435. Control device 400 may optionally include one or more buttons 415, and may include a roller ball 420 for position control. Alternatively, control device 400 may include mechanical, opto-mechanical, optical devices or other known position controllers in place of roller ball 420. Rotation detector 425 is configured to detect rotations of scroll wheel 405 and encode the rotations. Feedback device 410 is configured to provide a feedback force on the scroll wheel as the scroll wheel is rotated by a user. Feedback forces placed on the scroll wheel are generated and applied to the scroll wheel to coincide with encoded rotation signal that are generated by rotation detector 425. The encoded rotation signals may be provided to a computation device, such as a personal computer or the like to control graphical objects. Providing force feedback to the rotation wheel, a user feels tactile feedback that coincides temporally with the encoding. Further, providing force feedback to the scroll wheel rather than the scroll wheel generating force feedback via, for example, a ratcheting mechanism, eliminates difficulties associated with temporally aligning the force feedback with an encoding signal. According to another embodiment, control device 400 includes a vibration device 440 that is configured to provide vibrations to the roller wheel as the roller wheel is rotated. The vibrations temporally coincide with encoded rotation signals generated by the rotations detector. The vibration device might further be configured to generate sounds that temporally coincide with the encoded rotation signals. Controller 435 may be configured to provide a variety of signals to the feedback device and/or to the vibration device to control the type of feedback provided to the user. For example, signals may be provided by controller 435 to increase or decrease the number of force feedback signals or vibrations signals provided respectively by the feedback device and the vibrations device as the scroll wheeler is rotated faster or slower. Further, the intensity of feedback forces may be varied according, for example, to a user preference. A user may even choose that the feedback device and vibration device operate together, or that the feedback device provide no force feedback on the roller wheel while vibrations are applied by the vibrations device, or that no vibrations are applied to the roller wheel by the vibration device while force feedback is applied to the roller wheel by the feedback device. The controller may similarly be programmed to control the audible feedback. Further yet, the controller may control the feedback device to provide a variety of resistance levels to the scroll wheel based, for example, on a user preference. As resistance levels are varied, so to may be the amount of torque a user would apply to the scroll wheel to effect rotation of the scroll wheel. Reducing an amount of torque that is be applied to the scroll wheel to rotate the scroll wheel is beneficial, for example, for reducing stress on the muscles and joints in a user's hand. Feedback device 410 may include a number of devices configured to provide feedback forces on the scroll wheel. For example, feedback device 410 may be a device configured to provide magnetic pulses on a scroll wheel 405 that is metallic or that includes magnets. The feedback device may include a motor having a weight that applies feedback forces, a piezoelectric device, a solenoid or other known devices or devices in use at the time. The controller may provide signals to the feedback device and/or the vibration device to change the number of pulses or vibrations per turn of the roller wheel according to a user preference or a particular application or window in use. Controller 435 may also be configured to perform other functions of the pointing device, such as button control, or control of roller ball 420. Controller 435 may be a microcontroller, a microprocessor, control logic, an ASIC (application specific) device or the like.

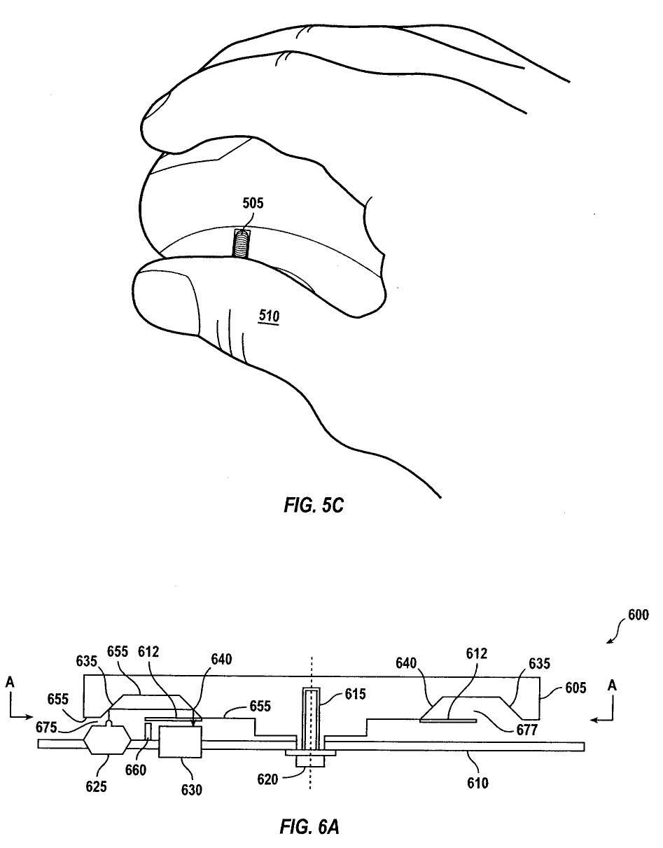

FIGS. 5A, 5B, and 5C are varying views of a control device 500 having a scroll wheel 505 disposed on a side of the control device according to an embodiment of the present invention. Control device 500 may be a mouse type device, other control device, for controlling a computation device, such as a personal computer or the like. Scroll wheel 505 is disposed proximate to a position where a user's thumb 510 is positioned during normal operation of the control device. The direction the scroll wheel is configured to rotate is configured to coincide with a thumb's natural motion and impart a minimal amount of stress on a thumb, hand, and wrist. While the scroll wheel is shown as being disposed slightly askew of vertical, the scroll wheel may be disposed at a number of different angles to provide for natural and comfortable thumb motion in use of the scroll wheel. In addition to providing a scroll function, the scroll wheel may also provide a button function. More specifically, the scroll wheel may be configured to be pushed to activate a button mechanism (not shown). Button activation may be used for traditional selection and dragging of graphical object or other functions in use at the time. According to a further embodiment, scroll wheel 505 is configured to be titled forward and back as indicated by arrows 520 and 525. The scroll wheel may be tilted by a user pushing forward or backward on the scroll wheel, for example, with the user's thumb. A forward push and tilt may be configured to activate a first button device (not shown) and a backward push and tilt may be configured to activate a second button. The first and second buttons may be used for additional control functions, such as scrolling control of graphical objects, selection control, for control of two dimensions of a three-dimensional graphical object (e.g., rotation along the x, y, or z axis, translations along the x, y, or z axis) or the functions.

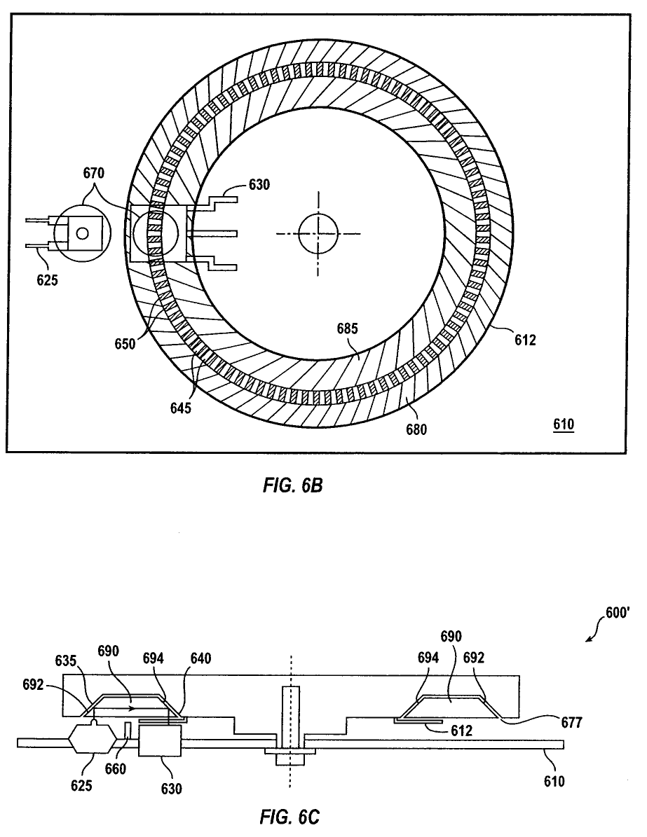

FIG. 6A is a simplified cross-sectional view of a dial controller 600 according to an embodiment of the present invention. Dial controller 600 may be used in a number of device types for control purposes. For example, dial controller 600 may be used on a keyboard, mouse, trackball, personal digital assistant (PDA), cellular phone, MP3 player, camera, radio, TV, hifi system, CD-player, speakers, etc. Dial controller 600 may be used in combination with a keyboard for volume control of a computer system or the like. Dial controller 600 may also be disposed in a vertical configuration for use as a scroll wheel in a mouse type device or the like.

Dial controller 600 includes a dial 605 mounted on a printed circuit board (PCB) 610 and an encoder disk 612 coupled to the dial. FIG. 6B is a simplified top view of encoder disk 612 and PCB 610. The view of the decoder disk in FIG. 6B is along line A-A of FIG. 1A. Dial 605 is configured to be rotated by a user for control of a parameter. Dial 605 may be mounted to the PCB board by a variety of means. For example, the dial may be configured to rotate on a spindle 615 and be held on the spindle with a fastener 620, such as a screw. Also mounted on the PCB are a radiation source 625 and a radiation detector 630. Radiation source 625 may be an LED or the like. Radiation detector 630 may be an opto-electronic device, such as a double-photo transistor, charged coupled device (CCD), complimentary metal oxide semiconductor (CMOS) device or the like. For example, the radiation source and radiation detector may include one of the sources and detectors described in U.S. Pat. No. 5,680,175, U.S. Pat. No. 6,552,716, or U.S. Reissued Pat. No. RE37,878, which are incorporated by reference herein in their entirety, and are owned by the owner of the presently described invention.

Dial 605 includes an outer beveled surface 635 and an inner beveled surface 640. Surfaces 635 and 640 are configured to reflect radiation from radiation source 625 to radiation detector 630. Surfaces 635 and 640 may be polished (e.g., polished plastic) to reflect the radiation or may be coated to enhance reflection. For example, surfaces 635 and 640 may be coated with metal, such as polished aluminum or chrome. Encoder disk 612 is configured to rotate with dial 605 and is configured to transmit and block the radiation, which is directed toward the detector by surfaces 635 and 640, in a repeating manner. While surfaces 635 and 640 are shown as being relatively flat, these surfaces may be curved to focus radiation into radiation detector 630. To alternately transmit and block the radiation, encoder disk 612 may be formed from a radiation blocking material and have slots 645 formed therein, such that the slots transmit radiation to the radiation detector, and bars 650 between the slots block the radiation from reaching the radiation detector. Alternately, encoder disk 612 may be formed from a transparent material and may be coated with stripes of a radiation blocking material to from transmission and anti-transmission regions of the encoder disk. The increase and decrease of the detected radiation are encoded by the radiation detector to provide control signals to an electronic device, such as a personal computer. According to one embodiment, surfaces 680 and 685 that are adjacent to the slots and bars may be anti-reflective (e.g., black) to inhibit stray light from entering the sensor. Surfaces adjacent the beveled surfaces, such as surfaces 655, may also be anti-reflection surfaces to minimize the amount of stray light scattered into the radiation detector. According to a further embodiment, a barrier 660 is disposed between radiation source 625 and radiation detector 630 to further reduce the amount of stray radiation that enters the detector.

The radiation source and radiation detector may be surface mount devices (SMDs). The radiation source and radiation detector may be mounted on the top or bottom surface of the PCB. If the radiation source and/or radiation detector are mounted on the bottom surface of the PCB, apertures (such as apertures 670) may be formed in the PCB for allowing radiation to travel through the PCB. These apertures may also serve as references for the relative positions and/or orientations of the radiation source, the radiation detector, and/or the axis of rotation of the dial. While the radiation emitting portion 675 of the radiation source is shown below cavity 677, according to some embodiments, the radiation emitting portion is disposed within cavity 677.

FIG. 6C is a cross-sectional view of a dial controller 600′ according to another embodiment of the present invention. The same numeral scheme used above to identify elements of dial controller 600 will be used to identify similar elements of dial controller 600′. Dial controller 600′ differs from dial controller 600 in that dial controller 600′ includes an insert 690 disposed in cavity 677. Insert 690 includes surfaces 692 and 694 that are adjacent surfaces 635 and 640, respectively, and that are disposed at or above the critical angle, such that the radiation is totally internally reflected within the insert at surfaces 692 and 694. To effect relatively high total internal reflection surfaces 692 and 694 may be polished. Insert 690 may be coupled to dial 605 by mechanical means (not shown) such as clips, screws or the like. While surfaces 692 and 694 are shown as being relatively flat, these surfaces may be curved to focus light into radiation detector 630. For example, insert 690 may have a toroidal shape.

According to an alternate embodiment, insert 690 has a plurality of slots formed therein to concentrate radiation on the radiation detector and a plurality of dispersive regions, wherein each slot is adjacent a dispersive region. The slots might be formed to concentrate the radiation into an area that is about half (or less) the width of a radiation sensing portion of the radiation detector. According to the embodiment presently described, the dial may not include an encoder disk. Each of the dial controllers described above may be configured to be pressed (or “clicked”) to activate a button type function.

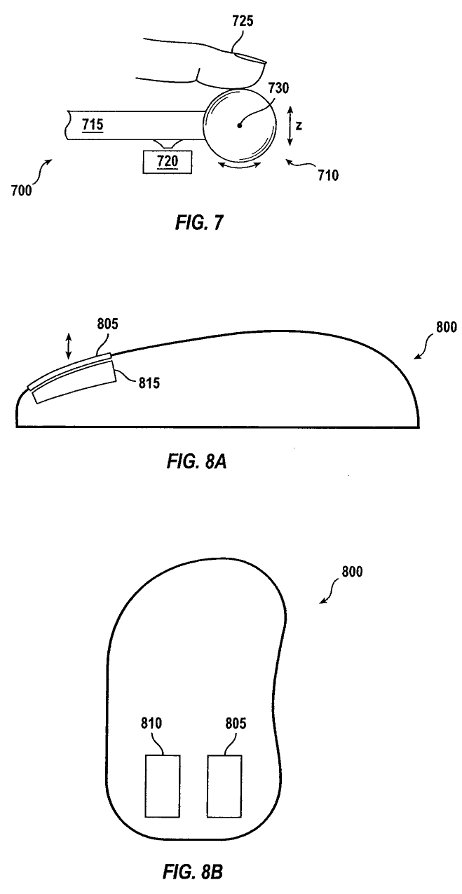

FIG. 7 is a simplified schematic of a scrolling structure 700 that may form a portion of a mouse or the like according to an embodiment of the present invention. Scrolling structure 700 includes a scroll wheel 710, a scroll wheel support 715, and a button 720 that may be activated by pushing in a downward direction on the scroll wheel. The scroll wheel may be rotated and pushed down by a user using a finger 725, for example. Button 720 is activated by a user pushing and releasing the scroll wheel or pushing down and holding the scroll wheel down while scrolling. Scroll wheel 710 is mounted on a low friction bearing 730 to minimize rotational friction while rotating. Scroll wheel 710 is configured not to ratchet while rotating to further minimize rotational friction. The scroll wheel also has a relatively large mass, such that the scroll wheel will continue to rotate (e.g., for an extended period) after a user has imparted a rotational momentum on the scroll wheel. Providing a wheel with a relatively large mass and low rolling friction without ratcheting provides for simplified scrolling through a large number of lines and/or pages displayed on a monitor. The scroll wheel may be configured to scroll through a plurality of text pages or a plurality of lines via a single push by a user to spin the scroll wheel. The scroll wheel may have a relatively high moment of inertia (e.g., made of a relatively dense material and with relatively high perimeter weighting), a relatively low friction bearing. For example, 80% or more of the scroll wheel's mass may be disposed in a portion of the scroll wheel that is at or exceeds 80% of the radius of the scroll wheel (i.e., ≧0.8×r of scroll wheel). Further, the scroll wheel may be configured not to provide a force feedback (ratcheting) limit friction forces on the scroll wheel. According to a specific embodiment, the scroll wheel is coupled to a motor (not shown) that is configured to provide a controllable torque to the scroll wheel to simulate a scroll wheel having a relatively high moment of inertia. The torque applied to the scroll wheel might be controlled by controlling the current supplied to the motor. According to a further embodiment, scroll wheel 710 provides for scrolling that is less than a line width displayed on a computer monitor and may provide pixel level scrolling.

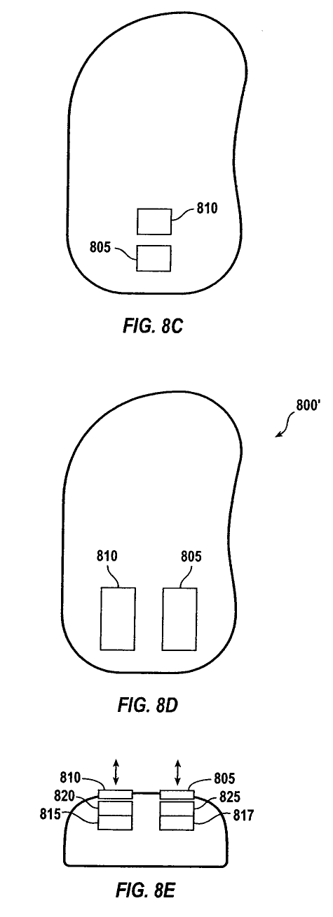

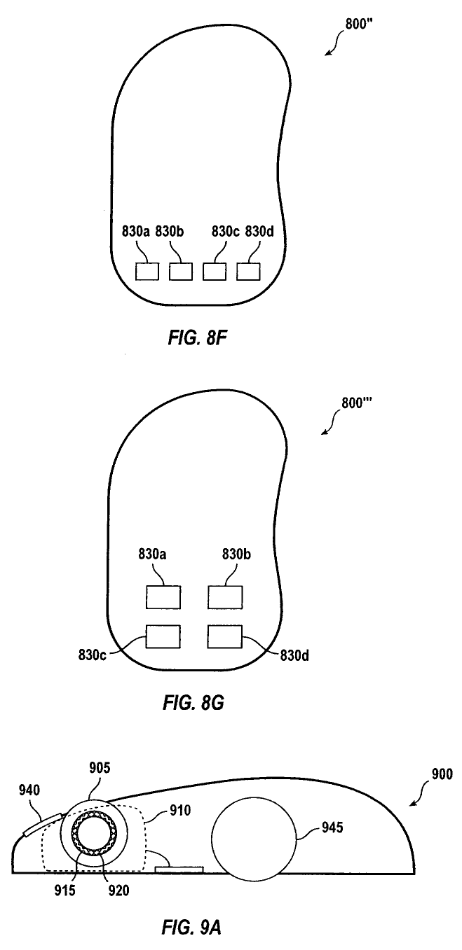

FIGS. 8A and 8B are simplified cross-sectional and top views of a control device 800 according to an embodiment of the present invention. Control device 800 may be a mouse type device or the like. Control device 800 includes first and second buttons 805 and 810, respectively, and includes first and second button sensing devices that are respectively associated with the first and second buttons. A first button sensing device 815 is shown in FIG. 8A. The sensing devices detect pressure or depression of the buttons and are configured to encode scrolling commands. The scrolling commands may be used by a computing device, such as a personal computer, for cursor scrolling, page scrolling or the like. For example, button 805 and its associated sensing device 815 may be configured to control downward scrolling, whereas button 810 and its associated sensing device (not shown) may be configured to control upward scrolling. According to one embodiment, a short push on one of the button provides for a scrolling amount that is equivalent to a single ratchet of a conventional scroll wheel. A longer durational push may provide for extended scrolling that is equivalent to a number of ratchets of a conventional scroll wheel. Alternatively, a light push (for example, if the sensing devices are pressure sensitive) on one of the buttons may provide for a single ratchet of scrolling, whereas a more firm push may provide for extended scrolling (e.g., multiple ratchet equivalents). Alternatively, a harder push may provide relatively fast scrolling, whereas a lighter push may provide for relatively slow scrolling and relatively fine scroll control. The sensing device may be force sensors, such as piezoelectric devices, a piezoresistivity device, such as a piezoresistivity conductive polymer that changes resistance in a predictable manner with the application of a force at its surface, such as the Force Sensing Resistors™ of Interlink Electronics of Carpinteria Calif., or other similarly functioning force detection devices. While buttons 805 and 810 are shown as being disposed on top of the mouse, the buttons may be disposed at a variety of locations, such as on the sides of the control device, or on the top and side of the control device. Further, while buttons 805 and 810 are shown as being disposed side by side, one button may be placed in front of the other as shown in FIG. 8C.

FIGS. 8D and 8E are simplified schematics of a control device 800′ showing top and front views of the control device according to another embodiment of the present invention. Control device 800′ differs from control device 800 described above in that control device 800′ includes a first switch device 820 coupled to first button sensing device 815, and includes a second switch device 825 coupled to second button sensing device 817. While the sensing devices are shown in FIGS. 8D and 8E as being disposed below the switch devices, the sensing devices may alternately be disposed above the sensing devices or in other locations. According to one embodiment, sensing devices 815 and 817 are configured to control a scrolling rate of a graphical object based on the level of force detected by the sensing devices. For example, as a user increases the amount of force placed on button 805 or 810, sensing device 817 or 815, respectively, are configured to detect the increasing amount of force and correspondingly increase the scrolling rate. According to one embodiment, the scrolling rate is not effected by the sensing devices until either switch 820 or 825 is activated. That is, regardless of the pressure detected by the sensing devices, scrolling is not commenced until one of switches 820 or 825 is activated. According to one embodiment, scrolling is initiated if the force detected by the sensing devices is greater than a threshold force. Implementing a threshold force to initiate scrolling inhibits inadvertent scrolling that is not intended by the user.

FIGS. 8F and 8G are simplified top view of control devices 800″ and 800″′ that include four buttons 830a-830d, that may be configured to control scrolling along two axes, such as along the x- and y-axis, along the x- and z-axis, along the y- and z-axis or the like. Buttons 830a-830d may be coupled to switches and or sensing devices, such as those described above, to control a scrolling and a scrolling rate of graphical objects displayed on a display. While buttons 830a - 830d are shown aligned and in a rectangular pattern in FIGS. 8F and 8G, respectively, the buttons may be disposed on various positions for finger and thumb control or the like.

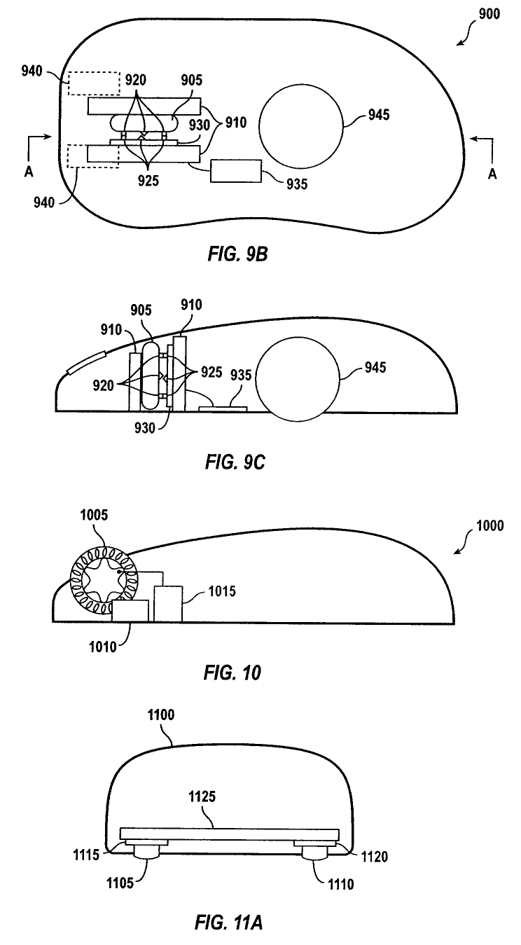

FIGS. 9A and 9B are simplified top and side views of a control device 900 according to an embodiment of the present invention. The view of control device 900 in FIG. 9A, as compared with the view in FIG. 9B, is along a plane that is perpendicular to the plane of the page and includes line A-A. Control device 900 may be a mouse type device or the like. Control device 900 includes a scroll wheel 905 and a support structure 910 that is configured to support the scroll wheel along an annular portion 915 of the scroll wheel. The annular portion of the scroll wheel includes a plurality of teeth 920. Three of the teeth 920 that are in the annular portion 915 of the scroll wheel are shown in the top view of the control device in FIG. 9B. More specifically, FIG. 9B shows two of the teeth 920 near a middle position of the scroll wheel and one tooth near a top position of the scroll wheel. All of the teeth 920 are shown in the side view of the of the control device in FIG. 9A. Teeth 920 are configured to interleave (or mesh) with a corresponding plurality of teeth 925 of the support structure. Teeth 925 are configured similarly to teeth 920. Teeth 925 might be disposed on a ring 930 of the support structure and might be configured to rotate as the scroll wheel is rotated by a user. Three of the teeth 925 are shown on ring 930 in the top view of the control device in FIG. 9B. More specifically, FIG. 9B shows two of the teeth 925 near a middle position of the scroll wheel and one tooth near a top position of the scroll wheel. Ring 930 might be operatively coupled to an encoder 935 that is configured to encode rotations of the ring and thereby encode rotations of the scroll wheel. While teeth 920 and 925 are shown as generally triangular in shape, the teeth might have other shapes such as rectangular, rounded or other shapes. Also, while scroll wheel 905 and support structure 910 is shown as being configured to provide scroll wheel functions for a mouse type device, the scroll wheel and support structure might be included in other control devices for which it might be inconvenient to support the scroll wheel via a hub and axel assembly. Also, while scroll wheel 905 is shown in FIG. 9A as being configured for top access and use, the scroll wheel may also be disposed for side access and use as shown in FIG. 9C. In a side mounted position, the scroll wheel might provide thumb controlled operation of the scroll wheel. While FIG. 9C shows the scroll wheel vertically mounted, the scroll wheel might alternatively be mounted horizontally or mounted along another axis that provide comfortable thumb operation of the scroll wheel. The scroll wheel might also provide a button means (not shown) that is configured to provided the scroll wheel with a button function. For example, a user might press (or click) the scroll wheel to activate the button means. Control device might also include a plurality of buttons, such as buttons 940, and might include means to control the X-Y positions of graphical objects, such as a ball 945 operatively coupled to decoder 935 or a optical encoder (not shown) that is configured to control X-Y positions of graphical objects.

FIG. 10 is a simplified schematic of a control device 1000 according to an embodiment of the present invention. Control device 1000 may be a mouse type device or the like. Control device 1000 includes a scroll wheel 1005, an optical encoder circuitry 1010, and a ratcheting mechanism 1015. The optical encoder circuitry may include a radiation source, such as an LED and a photodetector configured to detect light from the LED and to encode rotations of the scroll wheel. The ratcheting mechanism is configured to provide tactile force feedback to the user. The ratcheting of traditional control devices is synchronized to generate optical encoding signals, for example, for scrolling control of a graphical object displaced on a computer monitor. Such synchronization complicates the configuration of typical ratcheting mechanisms making them costly to manufacture. The ratcheting mechanism 1015, according to embodiments of the present invention, is unsynchronized with optical encoding signals generated by the optical encoder circuitry 1010, and may therefore be mechanically simpler than traditional ratcheting mechanisms. According to a specific embodiment, the number of encoding slots in the scroll wheel is larger than the number (e.g., twice the number) of ratchet steps per turn of the scroll wheel. For example, the scroll wheel might include 48 slots for 24 ratchet steps per turn of the scroll wheel. The encoder used to encode rotations of the scroll wheel, might be configured to provide eight countable states for each ratchet step. According to one embodiment, the control device's microprocessor is configured to run adaptive algorithm program that is configured to provide encoding of scroll wheel rotations that are not aligned with the ratcheting steps. For example, if the scroll wheel remains stopped for a predetermined period of time (e.g., two seconds), the control device's position counter might be set to zero. When the scroll wheel starts moving again (i.e., rotated by a user), the countable states are counted (plus or minus for forward or back rotation of the scroll wheel), and when half of a counter state is passed (e.g., transition from counter state 4 to 5 or from counter state −4 to −5), a scroll wheel report is generated by the control device. The time at which the report is generated is configured to match the time at which the feedback ratchet is generated. As the microprocessor is configured to run the adaptive algorithm program, the report might be generated without requiring precise mechanical alignment of the slots and ratchet steps.

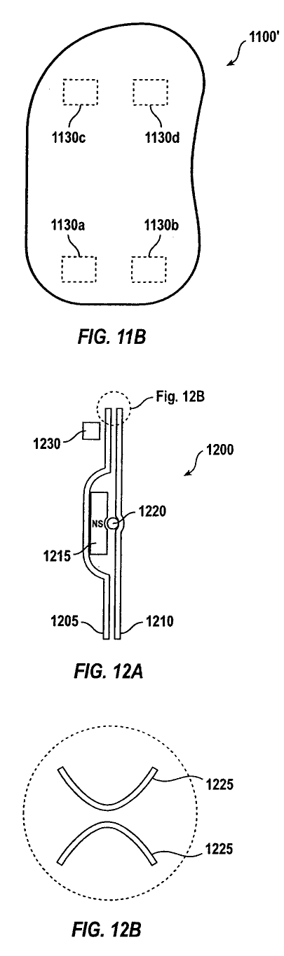

FIG. 11A is a simplified end view of a control device 1100 according to an embodiment of the present invention. Control device 1100 may be an optical-mouse device or the like. Control device 1100 includes first and second friction pads 1105 and 1110, respectively, disposed at the back end of the control device, first and second force sensors 1115 and 1120, respectively, and a printed circuit board 1125. According to one embodiment, the force sensors are coupled to a controller (e.g., a micro-controller) on the PCB board. The force sensors are configured to detect the pressure (or not) of a users hand on the control device and based on the force detected, the micro-controller program is configured to place the control device in a “sleep mode” (i.e., a reduced current consumption mode), leave the control device in a “power up mode” (i.e., normal operation mode), or to transition the control device from the sleep mode to the power up mode. For example, if hand pressure is not detected, the micro-controller may send a sleep mode signals to the various components of the control device to enter sleep mode. Providing such sleep modes, power consumption of the a control device is lowered, and may extends the life of the batteries used for battery powered embodiments.

FIG. 11B is a top view of a control device 1100′ According to another embodiment of the present invention. Control device include four force sensors 1130a, 1130b, 1130c, and 1130d (shown in phantom) disposed on the bottom of the control device 1100. The four force sensors may be configured to measure right and left torque applied to the control device and front-back torque applied to the control device, and compare the two torques to provide control signals, such as control signals to control horizontal scrolling and vertical scrolling of a graphical object. Specifically left-right torques may be detected by force sensors 1130a and 1130c and force sensors 1130b and 1130d, and front-back torques may be detected by force sensors 1130a and 1130b and force sensors 1130c and 1130d, essentially simultaneously. The detected torques may be compared and a control signal generated therefrom to control for example, horizontal scrolling of a graphical object. The comparison of the measured torques my include the use of differences or ratios of the measured torques for control signal generations. For example, right or left torque for controlling horizontal scrolling may be calculated by (a+c)−(b+d) and front or back torque may for controlling vertical scrolling may be calculated by (a+b)−(c+d), such that in a, b, c, and d refer to the torques about force sensors 1130a, 1130b, 1130c, and 1130d, respectively. The force sensors may include a variety of mechanisms such as force sensing resistors, piezoelectric sensors, capacitive sensors or the like. Control device 1100 may also include other input devices such as buttons, roller balls, scroll wheels or the like. The control device may include friction pads (not shown) that are not coupled to force sensors that provide a uniform platform for the control device to sit on so that the control device does not rock under the force of a user's hand.

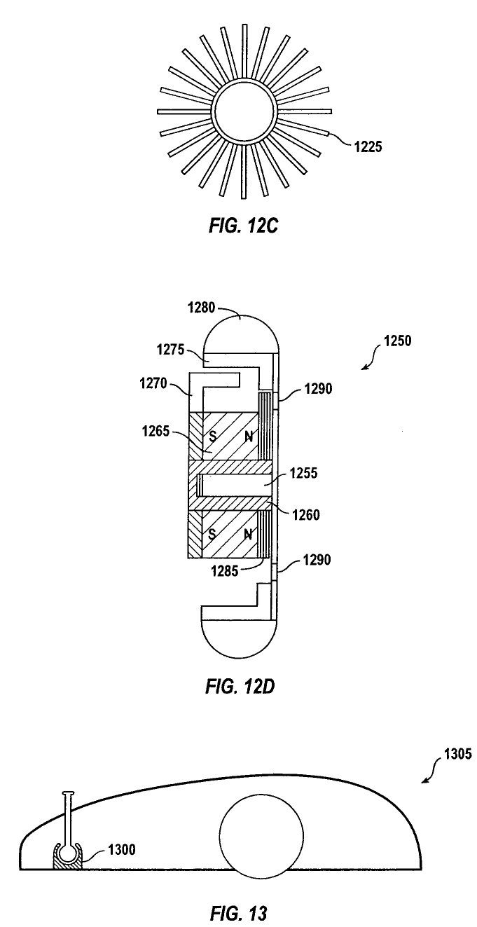

FIGS. 12A and 12B are simplified side views and FIG. 12C is a simplified top view of a scroll wheel mechanism 1200 according to an embodiment of the present invention. The scroll wheel mechanism provides low friction and low noise ratcheting (described in further detail below). The scroll wheel mechanism may be a portion of a scroll wheel of a mouse, a keyboard or the like. The mechanism includes a first and second toothed wheels 1205 and 1210, respectively, a magnet 1215, and a bearing 1220. The first toothed wheel is configured to be fixed and the second toothed wheel is configured to be rotated with respect to the first toothed wheel. The first toothed wheel may be mounted on the chassis of mouse, or the like, and the second toothed wheel may be mounted on the mouse's scroll wheel. Each toothed wheel includes, for example, 24 teeth 1225 that are magnetized by the magnet. The magnetic force between the teeth changes as the teeth are rotated past one another. As the teeth are aligned, the force between the teeth is at a maximum, and as the teeth are un-aligned, the force drops to a minimum. Further, the torque between the teeth is at a minimum for aligned teeth, and as the teeth are de-aligned torque on the teeth tries to realign the teeth. As the teeth pass the midpoint between two facing teeth, the torque that was opposing movement, acts to favor movement. The change in force between the teeth provides a ratcheting force on the scroll wheel that is felt as a tactile feedback force by a user. Depending on the shape and/or width of the teeth, the change in force between maximum force and minimum force may change rapidly or slowly providing for a strong or soft ratcheting force. For example, the teeth may be shaped to concentrate the magnetic field and enhance the magnetic force between the teeth at maximum. As shown in FIG. 12B, the teeth may be v-shaped to provide for magnetic field enhancement and magnetic force enhancement between the teeth. While the ratcheting force may be adjusted as desired, the friction between the first and second toothed wheel is relatively small as the wheels are mechanically coupled via the bearing mounted at their centers. While FIG. 12B, shows a single bearing mounted at the centers of the toothed wheels, a plurality of bearings may be used to rotationally couple the wheels. While a single magnet 1215 is shown in FIG. 12A as being disposed between the toothed wheels, a number of magnets may be used to magnetize the toothed wheels, for example, magnets may be mounted on the outsides of the toothed wheels rather than between the wheels. Alternatively, the teeth may each have a magnet mounted thereon. Alternatively, the toothed wheels may be magnets or each tooth may be a magnet.

According to one embodiment, the teeth on one or both of the toothed wheels may be used for encoding rotation of a scroll wheel. For example, a magnetic field detector 1225 may be mounted adjacent the teeth of the second toothed wheel that is mounted on a scroll wheel.

FIG. 12D shows a scroll wheel mechanism 1250 according to another embodiment of the present invention. Similar to scroll wheel mechanism 1200 described above, scroll wheel 1250 provides ratcheting via magnetic interactions. Scroll wheel mechanism 1250 includes a low friction bearing 1255 mounted in a bushing 1260, a magnet 1265 coupled to a stator 1270 and a rotor 1275, and a scroll wheel 1280. The stator may include a single arm or a plurality of arms. The rotor includes a plurality of arms (e.g., 24 arms) mounted inside the scroll wheel. The magnet may be cylindrical and surround bushing 1260. The arms of the rotor and the stator may be shaped (e.g., v-shaped) to concentrate the magnetic field lines between the arms when the arms are in close proximity to one another. A magnetic-field closure 1285 coupled to one end of the magnetic may be provided to enhance magnetic field transfer to the rotor. The magnetic-field closure may have a notched formed therein to allow radiation to interact with opto-encoder zones 1290 on the scroll wheel. The magnetic-field closer may be a 270° disk portion (i.e., disk with a 90° notch), and corresponds to removing a closer portion in an area proximate the optical barrier.

As the ratcheting forces provided by scroll wheel mechanism 1200 and 1250 are magnetically provided, rather than mechanical as provided by traditional scroll wheels, scroll wheel mechanism 1200 and 1250 provide for relatively low noise ratcheting. Moreover, as the ratcheting is not mechanically induced, the ratcheting characteristic tend not modify with use, unlike mechanical mechanism that tend to wear with use.

FIG. 13 is a simplified diagram of a control device 1300 disposed on a mouse type device 1305 according to an embodiment of the present invention. Control device 1300 is a stick shaped device (sometimes referred to as a “joystick”) configured to control the manipulation of graphical objects on a computer monitor or the like. According to one embodiment, pushing the control device with a first force causes graphical objects to scroll, translated or otherwise be manipulated at a first rate. For example, applying the first force to the control device in the x-directions causes screen scrolling in the x-direction at the first rate. According to a further embodiment, pushing the control device with a second force that is larger than the first force, causes scrolling, translation, and manipulation to occur at a second rate that is higher than the first rate. According to a further embodiment, the second rate will not activate until the second force has been applied to the control device for a preset period of time, for example, a ¼ of second, a ½ a second or any other desired period of time. According to another embodiment, scrolling, translation, or other manipulations of graphical objects have an increasing rate as the joystick is increasing moved from its neutral position. The increased movement from the neutral position may be associated with an increased restoring force, such as that described above. While control device 1300 is shown in FIG. 13 as forming a portion of a mouse type device, the control device may be included in other devices such as keyboards, keypads, trackballs or the like. According to some embodiment, the joystick is configured to be tilted from its neutral position by at least fifteen degrees. Such inclination provides comfortable finger (or hand) movement and provides a feedback that the joystick has been activated, for example, as compared with a joystick that is configured to provide essentially no movement (e.g., less than about one degree of tilt). Various joystick mechanisms and method of operation are described in detail in U.S. Pat. No. 5,911,627 and U.S. Pat. No. 6,248,018, which are incorporated herein by reference for all purposes, and are owned by the owner of the currently described invention.

The above-described arrangements of apparatus and methods are merely illustrative of applications of the principles of this invention and many other embodiments and modifications may be made without departing from the spirit and scope of the invention as defined in the claims. For example, while numerous embodiments of control devices have been described herein as including two button configured to provide a variety of control function, other embodiments of control devices might include more than two buttons to provide additional control functions according to various embodiments of the present inventions. The scope of the invention should, therefore, be determined not with reference to the above description, but instead should be determined with reference to the appended claims along with their full scope of equivalents.

What is claimed is:

1. A control device comprising
a case having a bottom surface that has a front portion and a back portion;
a first friction pad and a second friction pad disposed on the front portion of the bottom surface, wherein the first and second friction pads are configured to detect pressure from a user hand to power-up the control device, and wherein the first and second friction pads are configured to detect the absence of the user hand and place the control device in a sleep mode.

2. The control device of claim 1, further comprising a third friction pad and a fourth friction pad disposed on the back portion of the bottom surface, wherein the friction pads are configured to detect a first torque to control scrolling of a graphical object along a first axis of a display and to detect a second torque to control scrolling of the graphical object along a second axis of the display.

3. The control device of claim 2, wherein the first axis is an x-axis and the second axis is the y-axis.
